(19) United States
(12) Patent Application Publication
(10) Pub. No.: US 2025/0007202 A1
(43) Pub. Date: Jan. 2, 2025

(54) RECEPTACLE SYSTEM WITH A HOUSING POT MADE FROM SOFT MATERIAL

(71) Applicant: Neutrik AG, Schaan (LI)

(72) Inventor: Oliver Dobler, Tschagguns (AT)

(73) Assignee: Neutrik AG, Schaan (LI)

(21) Appl. No.: 18/739,873

(22) Filed: Jun. 11, 2024

(30) Foreign Application Priority Data
Jun. 27, 2023 (EP) 23181911.1
Nov. 3, 2023 (EP) 23207725.5

(51) Int. Cl. H01R 13/52

(52) U.S. Cl. CPC H01R 13/5202

(57) ABSTRACT

A receptacle system having a housing pot, a flange-like projection arranged at the insertion opening of the housing pot, and the housing pot is made from a material with a Shore A hardness from 60 to 100. The receptacle system moreover has a support ring made from a harder material than the housing pot, the housing pot can be passed through the support ring until the housing pot abuts the support ring with the flange-like projection such that, in a state mounted on the mounting plate, the flange-like projection is arranged between the mounting plate and the support ring. The support ring has a bore, in particular a blind bore, configured such that the support ring is fastened on the rear side of the mounting plate by a fastening element passed through the mounting plate from a front side of the mounting plate and engaging in the bore.

### CROSS-REFERENCE TO RELATED APPLICATIONS

This application claims priority from European Patent Application Numbers EP 23181911.1, filed Jun. 27, 2023, and EP 23207725.5, filed Nov. 3, 2023, both of which are incorporated herein by reference as if fully set forth.

### FIELD OF THE INVENTION

The present invention relates to a receptacle system, configured to receive a contact element carrier and at least one contact element received in the contact element carrier in order to form part of a built-in plug connector.

### BACKGROUND OF THE INVENTION

Built-in plug connectors with a multi-part structure are known from the prior art. The contact pins, often also referred to as sheets, are here pushed into a contact carrier, wherein, in addition to receiving and orienting the contact pins, this contact carrier inter alia also has the function of supplying the internal space into which the cable plug connector for establishing the contact with the contact pins is inserted. This internal space can additionally have elements for locking the cable plug connector. The contact carrier furthermore supplies in specific embodiments of such built-in plug connectors a flange which is designed to support the contact carrier and thus also the built-in plug connector at a region of a mounting plate surrounding a recess of the mounting plate. The flange can additionally have mounting bores through which, for example, screws for screwing the built-in plug connector to the mounting plate can be passed.

The contact carrier is pushed into a receptacle system in order to assemble the built-in plug connector, wherein this receptacle system is generally designed in the prior art as a one-piece built-in plug connector housing, wherein parts of the contact pins are pushed out of the built-in plug connector housing again through openings provided specifically for this purpose. These parts of the contact pins which project from the housing are then in each case connected, for example via terminals provided specifically for this purpose, to strands of a cable, for example a power cable, which supplies a signal, provided for transmission via the plug connection of built-in and cable plug connectors, for example a power supply signal.

In the case of built-in plug connectors of the prior art, the whole receptacle system or the whole built-in plug connector housing is manufactured from a hard, inelastic material (for example, a harder thermoplastic), wherein this harder housing does not bear as closely against the contact pins pushed out through the openings of the housing. These press fits between the built-in plug connector housing of the prior art and corresponding contact pins are consequently not tight/are permeable for dust, water, humidity, and/or gases, in particular air.

Such a lack of tightness between the housing and the contact pins is problematic in particular in the case of applications of the built-in plug connector outdoors (for example, loudspeakers at open-air festivals). Rainfall, for example, can occur here at any time, wherein water can penetrate into the built-in plug connector when no cable plug connector has been plugged in and the sealing cap provided for temporary closing and sealing of the internal space of the built-in plug connector has not been placed over it. The water which has penetrated can then flow as far as the press fit between the built-in plug connector housing and the contact pins and collect there. Because, as already mentioned above, this press fit is not tight because of the harder housing material, in particular with respect to water, there is a risk in the case of built-in plug connectors of the prior art that the moisture progresses further, into the appliance, and thus causes a short-circuit which can damage the appliance and in the worst case injure people standing around it.

Built-in plug connectors of the prior art solve the problem described by contact points of the contact pins with the housing being additionally sealed with sealing means such as, for example, adhesives, sealing pastes, sealing rings (for example, O rings), etc.

However, there is a disadvantage here of the built-in plug connector housing or the built-in plug connector of the prior art because these additional components/sealing materials cause, on the one hand, additional costs (for example, materials procurement costs, additional machines/staff) and, on the other hand, an additional amount of work by, for example, further work steps. Thus, for example, the corresponding sealing rings have to be inserted/plugged on, or the still liquid adhesive applied, for example, before the built-in plug connector is assembled by the receptacle system or built-in plug connector housing, the contact carrier, and the contact pins being plugged together.

### SUMMARY

The object of the invention is therefore to supply a receptacle system and a built-in plug connector which overcome the disadvantages from the prior art, in particular in light of the strict specifications with regard to safety and the worldwide established mounting dimensions.

A further object consists in supplying a receptacle system and a built-in plug connector in which the creation of tightness with respect to dust, water, humidity, and/or gases, in particular air, is simplified, as a result of which application outdoors, a reduced risk of short circuits, and/or compliance with specific standards are possible without additional amounts of work.

These objects are achieved by implementing one or more of the features disclosed herein. Features which develop the invention in an alternative or advantageous fashion can be found in the description and claims that follow.

The invention relates to a receptacle system, configured to receive a contact element carrier and at least one contact element received in the contact element carrier in order to form part of a built-in plug connector, wherein
the receptacle system has a housing pot, configured such that the contact element carrier can be inserted at least partially into the housing pot through an insertion opening at a plug-in-side end (or also: at a side/end provided as the side on the mounting plate for mounting of the receptacle system or the built-in plug connector on a mounting plate) of the housing pot, wherein a flange-like projection is arranged at the insertion opening of the housing pot, and
the receptacle system is provided to be applied and fastened, with the flange-like projection of the housing pot, against a rear side of a mounting plate, wherein
the housing pot is made from a material with a Shore A hardness in the range from 60 to 100 and the receptacle system moreover has a support ring which is made from a harder material than the housing pot, wherein
the housing pot can be passed through the support ring until the housing pot abuts the support ring with the flange-like projection such that, in a state mounted on the mounting plate, the flange-like projection is arranged between the mounting plate and the support ring, and
the support ring has a bore, in particular a blind bore, configured such that the support ring is fastened on the rear side of the mounting plate by means of a fastening means passed through the mounting plate from a front side of the mounting plate and engaging in the bore.

The embodiment according to the invention of the receptacle system/built-in plug connector with a housing pot made from a softer, more elastic material than in the case of receptacle systems/built-in plug connectors of the prior art has the advantage that the housing pot and the opening of the housing base can be manufactured with dimensions such that, on the one hand, when the contact element carrier is pushed in, which is manufactured for example from a harder plastic (for example, a harder thermoplastic), the housing pot is applied closely against said contact element carrier and, on the other hand, the opening of the housing base clings to the contact element which passes through it. In other words, the opening of the housing base has a somewhat smaller area than the cross-sectional area of that part of the contact element which is pushed out of the housing, through the opening of the housing base, such that the opening of the housing base expands when the contact element is pushed out, for which a certain force has to be applied. The area extending into the opening of the housing base then presses against the contact element with a force counteracting this expansion, as a result of which a so-called press fit is formed between the opening and the contact element. Because the housing pot of the receptacle system/built-in plug connector according to the invention is manufactured from a softer, more elastic material (for example, similar to rubber), it can, on the one hand, expand more easily and, on the other hand, cling better to the contact element. In this way, press fits between the soft, elastic housing pot and the harder, more inelastic contact element are impermeable to dust, water, humidity, and/or gases, in particular air, as a result of which in the mounted state the whole built-in plug connector is tight with respect to dust, water, humidity, and/or gases, in particular air, even if someone has forgotten to put the sealing cap over the plug-in opening of the built-in plug connector, for example when it is raining, and consequently water could enter the built-in plug connector.

By virtue of the water- and airtight press fit between the soft, elastic housing pot and the at least one contact element, the built-in plug connector having the receptacle system according to the invention is capable of complying with the standards IP65 or IP67, even when the sealing cap is not placed on it or the cable plug connector is plugged in, without the need to use additional components/sealing materials for this purpose (such as, for example, a liquid sealant which hardens after it has been applied). A saving can consequently be made by the receptacle system/built-in plug connector according to the invention, on the one hand, in additional costs (for example, material procurement costs, additional machines/staff) and, on the other hand, in additional amounts of work by, for example, further work steps. These additional costs/work steps thus do not occur in the case of the receptacle system/built-in plug connector according to the invention because no further sealing is necessary by virtue of the water- and air-impermeable press fits, for which reason the disadvantages of the prior art are overcome.

In an exemplary embodiment of the receptacle system according to the invention, the housing pot is made from a material with a Shore A hardness in the range from 65 to 95, in particular in the range from 75 to 95. The aspects of tightness and processability must be taken into consideration when selecting the hardness of the material, or when selecting the composition of the components which supply the hardness of the material. Namely, if the material is selected as too hard, then although the processability, in particular by means of injection-molding methods, is simplified, the sealing effect is, however, reduced. In the case of a material which is too soft, although the sealing effect is very good, delicate structures such as, for example, sealing lips are hard to manufacture (for example, undercuts are virtually impossible in an injection-molding method). In particular in the case of a Shore A hardness in the range from 65 to 95, both tightness and processability of the housing top are also ensured.

Because the support ring in the case of the receptacle system according to the invention is made from a harder material, the support ring is not distorted either when the fastening means is tightened or when the built-in plug connector is assembled, for which reason the support ring can exert an increased and additionally constant supporting effect on the housing pot.

By virtue of this optimized and permanent supporting effect of the support ring, the housing pot of the receptacle system according to the invention can be manufactured from a material which is softer than in the prior art, without the soft, flexible housing pot being distorted/deformed
when the built-in plug connector according to the invention is assembled, for example when the contact element carrier is inserted and/or the contact elements are pushed out of the openings of the housing base,
when the fastening means is passed through or when the corresponding fastening means is tightened which then exerts a certain contact pressure on the housing pot,
by the torque or leverage exerted by a built-in plug connector plugged into the contact element carrier,
by the tensile forces acting on the housing pot, caused by strands and/or terminals which are fastened to the contact elements which are passed through, and/or
by the gravity acting on the housing pot,
and contact regions between the components, in particular between the inner sides of the openings in the housing base and the contact elements which are passed through in each case thus becoming not tight with respect to dust, water, humidity, and/or gases, in particular air.

In an exemplary embodiment of the receptacle system according to the invention,
the material of the support ring has a Shore D hardness in the range from 60 to 100, and/or
a material of the contact element carrier has a Shore D hardness in the range from 60 to 100.

Although a main function of the contact element carrier is to receive the, in particular three, contact elements (also referred to as pins or sheets), the term contact element carrier is to be understood not only as just a contact element holder and instead the contact element carrier also has the task of supplying the socket for receiving the cable plug and elements for locking the cable plug in this socket. Furthermore, in specific embodiments, the contact element carrier supplies the flange, through the recesses of which are passed fastening means for fastening (for example, screws for screwing on) the contact element carrier to the mounting plate (for example, of a loudspeaker box). The contact element carrier thus serves also to serve as a type of skeleton or support structure which receives the further parts of the built-in plug connector or is surrounded by them, and, as a supporting and shaping structure, spans for example the built-in plug connector internal space which is provided to receive and lock the cable plug connector.

If the contact element carrier is manufactured from a harder material in addition to the support ring, the housing pot is additionally supported from inside, which prevents abovedescribed deformation of the housing pot (combined with a lack of tightness of the built-in plug connector) and generally stabilizes the receptacle system according to the invention or the built-in plug connector according to the invention. The hard plug-in-side end and the hard flange of the contact element carrier, in particular around the recesses of the flange of the contact element carrier, furthermore form a hard stop against the rear side of the mounting plate when the fastening means is tightened, wherein this hard stop prevents, by virtue of the contact pressure caused by the tightening of the fastening means, the flange-like projection, which is likewise made from the soft material and is likewise applied against the rear side of the mounting plate, from not being compressed to such an extent that undesired deformation of the flange-like projection occurs (for example, the flange-like projection is squeezed out laterally between the rear side of the mounting plate and the installation flange of the support ring), in particular at the recesses of the flange-like projection. Such undesired deformation of the flange-like projection, in particular at the recesses of the flange-like projection, could in turn cause lack of tightness inside the built-in plug connector according to the invention.

By virtue of the configuration of the support ring and the contact element carrier from the harder, less flexible material than the housing pot, the handleability of the receptacle system or the built-in plug connector is facilitated because, when the receptacle system or the built-in plug connector is installed on the mounting plate of an appliance, the installer can tighten the fastening means (for example, screws or bolts) firmly until a stop position is sensed, without the above-described squeezing-out of the flange-like projection occurring. The likelihood of damage to the built-in plug connector during the installation is furthermore reduced by the harder, more stable components.

In a further embodiment of the receptacle system according to the invention, the material of the housing pot, the material of the support ring, and/or the material of the contact element carrier consists at least predominantly of a plastic, in particular wherein the plastic is a thermoplastic, in particular one of the following thermoplastics:
polypropylene,
polyethylene,
polyurethane (for example, “thermoplastic polyurethane”), or
further thermoplastic elastomers (for example, styrene-ethylene-butylene-styrene (SEBS)), or
polystyrene.

The material of the housing pot can thus consist, for example, of the plastic at at least 60%, in particular at least 80%, wherein additives such as, for example, softeners or fire-protection substances are added to the plastic. In particular for built-in plug connectors of the powerCON type (powerCON chassis sockets) from the Liechtenstein-based company Neutrik AG, also known by the name Neutrik Group, it is very important that the material of the housing pot is flame-retardant, which is achieved for example by the addition of fire-protection substances to the material of the housing pot.

In a further embodiment of the receptacle system according to the invention, the housing pot, the support ring, and/or the contact element carrier is manufactured by means of injection-molding methods, 3D printing methods, pressing methods, or vulcanization methods.

The use of a thermoplastic (or a thermoplastic elastomer) as the main constituent for the soft material has, inter alia, the advantage that manufacturing of the housing pot can be achieved by means of injection-molding methods, 3D printing methods, pressing methods, or vulcanization methods, and that the housing has an insulating effect with respect to electrical current.

Because the housing pot, the contact element carrier, and/or the support ring are manufactured as a single piece, there are no contact points, gaps, transitions, etc within the respective component at which lack of tightness can occur or which need to be sealed additionally by means of O-rings or adhesives. In this way, a saving is also made in sealing materials and working steps compared with the prior art. Furthermore, a plurality of functions are combined within the respective component, which in turn enables simplified handling (or simplified assembly because fewer parts need to be plugged together).

The injection-molding method enables simple manufacturing of the respective components of the receptacle system/built-in plug connector according to the invention and in particular simple manufacturing of the housing pot. For manufacturing by means of injection-molding methods, it is required that the material used is first melted and can then be injected into the corresponding mold. The material must furthermore be capable of solidifying in the corresponding mold by cooling and maintaining this solidified form until it is heated again. It is therefore particularly advantageous that the materials of the receptacle system/built-in plug connector according to the invention have a thermoplastic plastic or consist predominantly of this thermoplastic (or thermoplastic elastomer) (additives such as softeners or fire-protection substances are often added in), because a large number of the thermoplastics have the abovedescribed properties and can therefore be used for the injection-molding method. Furthermore, some thermoplastics have a Shore hardness, in particular amorphous thermoplastics such as low-density polyethylene (LD-PE), atactic polypropylene (PP-at), or atactic polystyrene (PS-at), which is very close to the Shore hardness of the soft material of the housing pot.

Because the contact element carrier and the support ring are provided to form the support structure/skeleton of the built-in plug connector, it is particularly advantageous if the contact element carrier and the support ring are made from a harder material than the housing pot. Because, in an advantageous embodiment, the contact element carrier and the support ring are manufactured in exactly the same way as the housing pot by means of injection-molding methods, 3D printing, pressing, or vulcanization, it is particularly advantageous if the material of the contact element carrier and the support ring has a thermoplastic, in particular consists predominantly of this thermoplastic. Semi-crystalline thermoplastics such as, for example, isotactic PP, isotactic PS, or high-density polyethylene (HD-PE) are possible for this purpose.

Advantages of producing the respective components of the receptacle system/built-in plug connector according to the invention by means of injection-molding methods are that the injection-molding method, on the one hand, allows production with high precision and, on the other hand, different components (for example, plastic and fire-protection agents) can be mixed together in different proportions “like a recipe”. A check can then be made as to whether the end product has the desired material properties in the recipe used and the recipe can be adapted if necessary.

A further advantage of an embodiment of the receptacle system/built-in plug connector according to the invention compared with the prior art consists in the housing pot having the abovementioned Shore A hardness despite the addition of a flame-protection agent. The production of such a flame-retardant V0 material in this Shore A hardness range is a big challenge as hitherto materials which would be provided with such flame protection become very hard and brittle and thus lose their sealing effect. Flame protection is very important in particular for powerCON-type plug connectors because compliance with the standard UL 94 is required for these plugs (i.e. the material and the plugs must be certified V0 in accordance with UL94 at 1 mm). Because of the standards or the requirements of these standards, it is advantageous that flame protection (a certain proportion of a flame-retardant additive) is added to this material. The protection category can be determined via the percentage of the flame-retardant additive which is added to the total mixture.

In a further embodiment, the material of the housing pot can furthermore also be UV-stabilized (in accordance with UN standard UL50E, and thus needs a UL certificate f1). For this purpose, UV stabilizers of 10-15 wt % (percentage by weight) or 10-15 mol % (mole percentage) or 10-15 vol % (percentage by volume) are added to the material. By virtue of the UV stabilization, the receptacle system/built-in plug connector according to the invention can be used outdoors. By way of example, the “True Outdoor Protection” (TOP) product line from the Liechtenstein-based company Neutrik AG, also known by the name Neutrik Group, can be used.

The soft material of the housing pot of the receptacle system according to the invention is moreover designed in such a way that so-called undercuts can also be formed during the manufacture of the housing by means of injection-molding methods, which enables, for example, the configuration of the sealing lip or the wall-like raised portion.

In a further embodiment of the receptacle system according to the invention, the housing pot moreover has:
a housing base at a rear-side end, situated opposite the plug-in-side end, of the housing pot, and
a housing shell extending from the insertion opening as far as the housing base,
wherein a radial extent (in other words: the diameter or the dimension) of the support ring and a radial extent (in other words: the diameter or the dimension) of the housing shell are matched to each other in such a way that, when the housing pot is passed through the support ring, the housing shell bears against an inner side of the support ring and is supported by it,
in particular wherein the support ring has an extent running axially in a direction of passage of the housing pot through the support ring (which corresponds also to the direction in which the center axis of the housing pot runs from the plug-in-side end toward the housing base, the direction of insertion of the contact element carrier into the housing pot, and the direction in which the cable plug connector is plugged into the contact element carrier (or the direction in which the cable plug connector is plugged into the built-in plug connector)) such that at least 50% of the housing shell can be supported by the support ring.

In a further embodiment of the receptacle system according to the invention, the housing base has:
an opening provided such that, when the contact element carrier is inserted, together with the contact element, at least partially into the housing pot through the insertion opening in order to form part of the built-in plug connector, at least a part of the contact element is passed through the opening such that at least that part of the contact element which is passed through the opening of the housing base is present on an outer side of the housing base, and/or
an element, running around the opening of the housing base, which engages with a corresponding mating element of the contact element carrier, wherein the contact element carrier can be fixed in the housing pot by the engagement of the element and the mating element,

in particular wherein
a contact region formed between the contact element which is at least partially passed through and an inner side of the opening of the housing base, and/or
a contact region formed between the element and the mating element is impermeable with respect to dust, water, humidity, and/or gases, in particular air.

The opening in the housing base is here adapted to the shape of the contact element in such a way (for example, the opening has the same shape and the same or even smaller area than the cross-sectional area of the contact element) that, when the contact element is pushed out, the edge region of the opening is pressed aside by virtue of the soft, flexible material of the housing pot without the edge region of the opening being turned inside out. In this way, the inner side of the opening is applied with its whole area against the contact element which is passed through, as a result of which the press fit formed thereby between the contact element and the inside of the opening is impermeable with respect to dust, water, humidity, and/or gases, in particular air. Housing pots of the prior art are made from a harder material, which is why in the case of these housing pots the edge region of the opening of the housing base is turned completely inside out when the contact element is passed through. Because of this distortion of the opening, the inner side of the respective opening can be applied against the contact element which is passed through with just a small area, which in turn causes lack of tightness of the press fit formed. Furthermore, when an edge region of the opening of the housing base is turned inside out, a low elevated pressure inside the built-in plug (for example, initiated by temperature fluctuations within a short period of time) is sufficient to push open the edge region and thus cause further lack of tightness of the press fit formed. Such sensitivity to fluctuations in pressure does not exist in the case of the built-in plug according to the invention because the inner side of the respective opening bears against the contact element which is passed through with its whole area, and the press fit formed thereby between the contact element and the inner side of the opening is considerably more stable.

In a further embodiment of the receptacle system according to the invention,
the element of the housing base is configured as a wall-like raised portion (raised into an inner region of the housing pot) which runs around the opening of the housing base and the mating element of the contact element carrier is configured as a raised receiving region formed to receive the contact element on the contact element carrier, or
the element of the housing base is configured as a depression having the opening of the housing base and the mating element of the contact element carrier is configured as a raised receiving region formed to receive the contact element on the contact element carrier.

In a further embodiment of the receptacle system according to the invention, the flange-like projection has a sealing lip running around the flange-like projection, wherein the sealing lip
is arranged on a side of the flange-like projection which is directed in the opposite direction to a direction of insertion of the contact element carrier into the insertion opening of the housing pot, and
is designed to be pressed against the rear side of the mounting plate when the support ring is fastened to the rear side of the mounting plate by means of the fastening means in order to supply a contact region, between the flange-like projection and the rear side of the mounting plate, which is impermeable with respect to dust, water, humidity, and/or gases, in particular air.

In a further embodiment of the receptacle system according to the invention, the flange-like projection has a recess, matched to the bore of the support ring, for the passage of the fastening means, in particular wherein the diameter of the recess corresponds at least approximately to the diameter of the bore.

In a further embodiment of the receptacle system according to the invention,
the support ring has, in particular on a side of the support ring which is directed in the opposite direction to the direction of passage of the housing pot through the support ring (in other words: on a side of the support ring from which the housing pot from which the housing pot can be moved toward the support ring in order to pass through it), a radially outwardly extending installation flange,
the installation flange of the support ring has the bore,
the housing pot can be passed through the support ring so far that the housing pot abuts the installation flange of the support ring with the flange-like projection, and/or
a radial extent of the flange-like projection and a radial extent of the installation flange are at least approximately the same, in particular wherein the flange-like projection comes to lie on the installation flange so that they are at least approximately congruent.

In a further embodiment of the receptacle system according to the invention,
the support ring has a shell surface extending axially in the direction of passage of the housing pot through the support ring,
the bore of the support ring is configured as an in particular one-piece blind bore which is arranged on an outer side of the shell surface of the support ring,
the blind bore is arranged on the outer side of the shell surface of the support ring in such a way that the blind bore ends flush with the installation flange on the side of the support ring which is directed in the opposite direction to the direction of passage of the housing pot through the support ring, in particular wherein an opening of the blind bore extends within the installation flange, and/or
the support ring has two in particular diagonally opposite blind bores, in particular wherein the openings of the two blind bores extend within diagonally opposite corners of the installation flange.

In a further embodiment of the receptacle system according to the invention, the support ring has, on the side of the support ring which is directed in the opposite direction to the direction of passage of the housing pot through the support ring, a depression into which a raised portion, designed correspondingly as a mating piece and arranged on a side of the flange-like projection which is directed in the direction of passage of the housing pot through the support ring (which corresponds to the direction of insertion of the contact element carrier into the insertion opening of the housing pot), can be pushed with an exact fit such that
a center axis of the housing pot and a center axis of the support ring are coaxial, and/or
the housing pot can be fixed on the support ring by means of a press fit which can be formed between the raised portion of the flange-like projection and the depression of the support ring.

In a further embodiment of the receptacle system according to the invention, the housing pot has, on the side of the housing pot which is directed in the opposite direction to the direction of insertion of the contact element carrier into the insertion opening of the housing pot, a depression into which a flange, formed correspondingly as a mating piece, of the contact element carrier can be pushed with an exact fit such that
the center axis of the housing pot and a center axis of the contact element carrier are coaxial,
the contact element carrier can be fixed on the housing pot by means of a press fit which can be formed between the flange of the contact element carrier and the depression of the housing pot, and/or
a plug-in-side end of the contact element carrier and the plug-in-side end of the housing pot form a plane surface, wherein the plane surface is designed to be applied against the rear side of the mounting plate.

In a further embodiment of the receptacle system according to the invention, the receptacle system moreover has a second support ring, wherein
the second support ring is provided to be fastened to the front side of the mounting plate by means of the fastening means, wherein the front side of the mounting plate is directed toward the side from which the cable plug connector can be moved toward the built-in plug connector situated in the state installed on the mounting plate,
the second support ring has a radially outwardly extending support flange, and/or
the second support ring has at least one recess extending in particular in a corner of the support flange of the second support ring, in particular wherein the second support ring, the housing pot, and the support ring can be arranged on the mounting plate in such a way that
   the center axis of the second support ring, the center axis of the housing pot, and the center axis of the support ring are coaxial,
   the recess of the support flange of the second support ring, the recess of the flange-like projection of the housing pot, and the bore of the support ring lie on top of one another approximately congruently, and/or
   the fastening means provided for fastening the receptacle system to the mounting plate and moved toward the front side of the mounting plate for this purpose can be passed through the recess of the support flange of the second support ring, through the recess of the flange-like projection of the housing pot, and through the bore of the support ring, in particular wherein, when the fastening means is passed through the recess of the support flange of the second support ring, through the recess of the flange-like projection of the housing pot, and through the bore of the support ring, the fastening means exerts a respective force on said components of the receptacle system, as a result of which the second support ring is pressed against the front side of the mounting plate, and the flange-like projection of the housing pot and the support ring are pressed against the rear side of the mounting plate and the fastening of the receptacle system to the mounting plate is thus reinforced.

In a further embodiment of the receptacle system according to the invention, the second support ring has a locking mechanism for the cable plug connector for the purpose of supplying a mechanically lockable plug connection, in particular wherein an internal space, designed for the passage of and/or to receive the cable plug connector, of the second support ring has a mechanical closing element which is provided in order to effect engagement of a catch, connected to the catch slide, of the cable plug connector into the closing element of the second support ring, as part of a locking mechanism of the second support ring which can be actuated by displacement of a catch slide on the cable plug connector, and thus to block the cable plug connector in terms of rotation in an unscrewing direction which is directed counter to a screw-in direction.

In a further embodiment of the receptacle system according to the invention, a partition element is arranged on an outer side of the housing base, wherein the partition element is designed to in particular electrically insulate that part of contact element which is passed through the opening in the housing base and is present on the outer side of the housing base from further contact elements, in particular from touching them.

The invention additionally relates to a built-in plug connector for making an in particular mechanically lockable plug connection to a cable plug connector matched to the built-in plug connector as a mating piece and which can be plugged into an opening of the built-in plug connector, wherein transmission of a signal, in particular a power supply signal, a digital signal, or an analog signal is enabled by making the plug connection between the built-in plug connector and the cable plug connector, wherein the built-in plug connector has:
at least one contact element, wherein the at least one contact element is provided to come into contact by making the plug connection with a contact element mating piece on the cable plug connector and consequently to supply the transmission of a signal via the plug connection, and
a contact element carrier, wherein the at least one contact element is received by the contact element carrier, wherein

the built-in plug connector moreover has a receptacle system according to one of the abovementioned aspects/embodiments, wherein
the housing pot is passed through the support ring until it abuts the flange-like projection, and
the contact element carrier is inserted, together with the at least one contact element, through the insertion opening at least partially into the housing pot of the receptacle system.

The at least one contact element is here, for example, received by the contact element carrier in such a way that a first subregion of the contact element is plugged in the contact element carrier and is fixed there, for example, by interlocking or being jammed in place, whilst a second subregion of the contact element projects from the receiving region of the contact element carrier. Because the contact element carrier is inserted so far into the housing pot that this receiving region abuts the housing base or the cavity, formed by the wall-like raised portion, on the housing base, the second subregion, projecting from the receiving region, of the contact element is pushed out of the housing pot through the opening of the housing base. It is consequently possible also to state that the at least one contact element is received at least partially by the contact element carrier and is thus fixed at least partially inside the built-in plug connector.

In a further embodiment of the built-in plug connector according to the invention, the contact element carrier has a locking mechanism for the cable plug connector for the purpose of supplying a mechanically lockable plug connection, in particular wherein an internal space, formed for the purpose of receiving the cable plug connector, of the contact element carrier
has a mechanical retaining element which is provided in order to block a retaining element mating piece on the cable plug connector in terms of an axial movement in the direction in which the cable plug connector is pulled out, in the form of a first part of a locking mechanism which can be actuated by rotation, in the screw-in direction, of the cable plug connector in the state in which the cable plug connector is pushed at least partially into the internal space, and/or
has a mechanical closing element which is provided in order to effect engagement of a catch, connected to the catch slide, of the cable plug connector into the closing element, in the form of a second part of the locking mechanism which can be actuated by displacement of a catch slide on the cable plug connector, and thus to block the cable plug connector in terms of rotation in the unscrewing direction which is directed counter to the screw-in direction.

In a further embodiment of the built-in plug connector according to the invention, the built-in plug connector is provided to make the mechanically lockable plug connection to a cable plug connector
of the 3-pole mains plug connector type, in particular wherein the built-in plug connector is designed as a 3-pole power supply chassis socket, or
to make the mechanically lockable plug connection to a cable plug connector of the following cable plug connector types
   IEC,
   XLR,
   RJ45,
   HDMI,
   USB, or
   RCA,
      in particular wherein the built-in plug connector is designed as a chassis socket adapted correspondingly to this cable plug connector type

In a further embodiment of the built-in plug connector according to the invention, the retaining element is arranged and configured in such a way that the retaining element mating piece engages behind the retaining element after the first part of the locking mechanism has been actuated.

In a further embodiment of the built-in plug connector according to the invention,
the mechanical retaining element is designed as a groove arrangement, wherein grooves of the groove arrangement first extend axially and consequently serve in particular as key mating pieces for key elements of the cable plug connector, and then perpendicularly to the axis or slightly obliquely to the perpendicular to the axis and serve in this region as retaining components, wherein the retaining element mating piece is designed as a tab arrangement which, when the plug connection is made, is inserted into the groove arrangement and blocked against being pulled out axially by the groove arrangement region running perpendicularly or slightly obliquely to the perpendicular to the axis, or
the mechanical retaining element is designed as a tab arrangement and the retaining element mating piece is designed as a groove arrangement, wherein grooves of the groove arrangement first extend axially in the plugged-in state and consequently serve as key elements for the tab arrangement serving in particular as key mating pieces, and then run perpendicularly to the axis or slightly obliquely to the perpendicular to the axis, wherein, when the plug connection is made, the groove arrangement region extending perpendicularly or slightly obliquely to the perpendicular to the axis engages behind the tab arrangement and consequently the cable plug connector is blocked against being pulled out axially.

In other words, the groove of the corresponding element runs initially axially and then becomes a transverse groove, i.e. is designed as an at least largely L-shaped groove. The tab, correspondingly designed as a mating piece, of the corresponding element is initially passed through the axial portion of the at least largely L-shaped groove and then engages into the transverse groove as soon as a rotational movement, for example of the cable plug connector having the tabs, is performed. The tab thus abuts the transverse groove in the case of movement in the axial direction or counter to the axial direction, i.e. for example when the cable plug connector is pushed in or pulled out, as a result of which, for example, the cable plug connector is prevented from being pulled out in an unplanned fashion and thus the plug connection is prevented from being disconnected in an unplanned fashion.

In a further embodiment of the built-in plug connector according to the invention, the retaining element is arranged in such a way that and is provided with an oblique profile in such a way that, by and during actuation of the first part of the locking mechanism, the retaining element mating piece is moved along the oblique profile until the retaining element mating piece meets a rotary stop and an end plug-in position of the cable plug connector in the internal space is reached.

In a further embodiment of the built-in plug connector according to the invention, the internal space has mechanical key mating pieces which are provided to interact with key elements, matched to the latter, of the cable plug connector in such a way that the cable plug connector can be pushed into the built-in plug connector in just one specific rotary orientation predetermined by the key mating pieces.

In a further embodiment of the built-in plug connector according to the invention, the contact element carrier is made from the same material as the support ring.

In a further embodiment of the built-in plug connector according to the invention, the flange of the contact element carrier is made from the same material as the contact element carrier, in particular wherein the material of the contact element carrier and the flange of the contact element carrier is harder than the material of the housing pot.

In a further embodiment of the built-in plug connector according to the invention, the flange, consisting of the harder material, of the contact element carrier is provided to form a stop when the plane surface formed by the plug-in-side end of the contact element carrier and the plug-in-side end of the housing pot is applied against the rear side of the mounting plate, and when the receptacle system and the contact element carrier is fastened to the rear side of the mounting plate by means of the fastening means, such that a deformation of the housing pot consisting of the softer material can be prevented by a contact pressure produced by the fastening means.

In a further embodiment of the built-in plug connector according to the invention, the flange of the contact element carrier has a recess, open in particular toward an outer side of the flange and matched to the bore of the support ring and/or the recess of the flange-like projection, for the passage of the fastening means, in particular wherein the diameter of the recess of the flange of the contact element carrier corresponds at least approximately to the diameter of the bore of the support ring and/or the recess of the flange-like projection.

In a further embodiment of the built-in plug connector according to the invention, the flange of the contact element carrier has two in particular diagonally opposite recesses for the respective passage of the fastening means, in particular wherein the recesses of the flange of the contact element carrier extend within diagonally opposite corners of the flange of the contact element carrier.

The contact element carrier is fixed in the housing pot, the housing pot is fixed in the support ring, and/or the contact elements are fixed in the contact element carrier in the case of the built-in plug connector according to the invention by correspondingly configured press fits (for example, the press fit between the element and the mating element, the press fit between the depression of the support ring and the raised portion of the flange-like projection, or the press fit between the flange of the contact element carrier and the depression of the housing pot) or clamping mechanisms (for example, between the contact element carrier, in particular the receptacle region of the contact element carrier and the contact element) in combination with the contact pressure exerted by the fastening means. In the embodiment shown of the built-in plug connector according to the invention, the use of adhesives or further fixing means such as, for example, further clamps, screws, etc can consequently be dispensed with, as a result of which the built-in plug connector according to the invention can be assembled simply.

Because the housing pot consists of the soft, flexible material which is pressed slightly aside when components are pushed in but is only elastically deformed because of the flexibility and thus fits tightly against the component, the press fits between the soft housing pot and the corresponding components, in particular the press fit between the inner side of the opening of the housing base and the contact element which is passed through, is already tight with respect to dust, water, humidity, and/or gases, in particular air, even without the additional use of sealing means such as, for example, adhesives, sealing pastes, sealing rings (for example, O-rings), etc. The establishment of tightness with respect to dust, water, humidity, and/or gases, in particular air, is consequently simplified by the receptacle system according to the invention or the built-in plug connector according to the invention, as a result of which application outdoors, a reduced risk of short-circuits, and/or compliance with specific standards are possible without any additional amount of work.

### BRIEF DESCRIPTION OF THE DRAWINGS

The receptacle system according to the invention or the built-in plug connector according to the invention will be described in detail below purely by way of example on the basis of exemplary embodiments illustrated schematically in the figures. The same elements are designated by the same reference signs in the figures. The embodiments described are generally illustrated as not to scale and they are also not to be understood as implying a limitation. In detail, in the drawings:

FIGS. 1A-1B: show perspective views of an exemplary embodiment of the built-in plug connector according to the invention having an exemplary embodiment of the receptacle system according to the invention in an exploded view,

FIGS. 2A-2B: show perspective views of an exemplary embodiment of the built-in plug connector according to the invention having an exemplary embodiment of the receptacle system according to the invention in an assembled state,

FIG. 3: shows a perspective view of an exemplary embodiment of the built-in plug connector according to the invention having an exemplary embodiment of the receptacle system according to the invention in an assembled state,

FIG. 4: shows a schematic illustration of the installation of an exemplary embodiment of the built-in plug connector according to the invention on a mounting plate.

### DETAILED DESCRIPTION

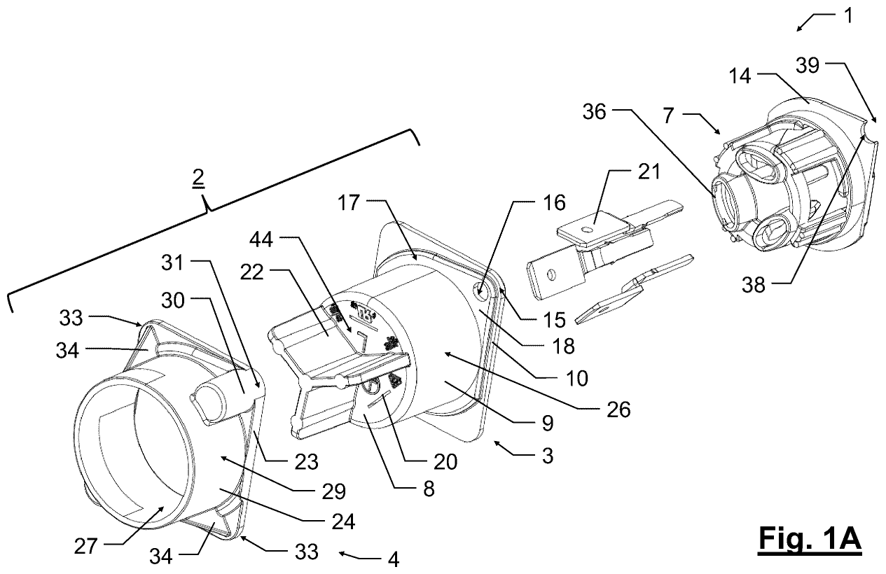

FIGS. 1A and 1B show perspective views of an exemplary embodiment of the built-in plug connector 1 according to the invention having an exemplary embodiment of the receptacle system 2 according to the invention in an exploded view.

In the exemplary embodiment shown, the receptacle system 2 has the housing pot 3 and the support ring 4. The housing pot 3 here has, at its plug-in-side end 5, the insertion opening 6 through which the contact element carrier 7 can be inserted at least partially into the housing pot 3, the (circular) housing base 8 situated opposite the plug-in-side end 5, and the cylindrical housing shell 9 extending from the insertion opening 6 as far as the housing base 8.

The housing pot 3 furthermore has, at the insertion opening 6, the flange-like projection 10 which extends in a radial direction and around which the sealing lip 11 runs, and the depression 13 arranged on that side 12 of the housing pot 3 which is directed in the opposite direction to the direction of insertion of the contact element carrier 7 into the insertion opening 6 of the housing pot 3. The depression 13 is provided to receive the flange 14 of the contact element carrier 7 with an exact fit and extends within the flange-like projection 10 as far as the two diagonally opposite corners 15 of the flange-like projection 10 in which the recesses 16 for the passage of the fastening means are arranged.

The raised portion 18 is arranged on that side 17 of the flange-like projection 10 which is directed in the direction of passage of the housing pot 3 through the support ring 4. The raised portion 18 is provided for being inserted with an exact fit into the depression 19, designed correspondingly as a mating piece, of the support ring, and likewise extends as far as the two diagonally opposite corners 15 of the flange-like projection 10 in which the recesses 16 for the passage of the fastening means are arranged. In the exemplary embodiment shown, the raised portion 18 of the flange-like projection 10 is formed by the depression 13 of the flange-like projection 10.

In the exemplary embodiment shown, three openings 20 for the respective passage of at least a part of the three contact elements 21 which are received by the contact element carrier 7 extend within the housing base 8.

In the exemplary embodiment shown, the housing pot 3 has, on that side 17 of the housing base 8 which is directed in the direction of passage of the housing pot 3 through the support ring 4 (in other words: on the outer side 17 of the housing base 8), a separating element 22, consisting of three separating walls starting from a common point, which separates those parts of the three contact elements 21 which are passed through the three openings 20 in the housing base 8 and are present on the outer side 17 of the housing base 8 from one another in such a way that it is not possible for the contact elements 21 to touch other electrically conductive components (for example, a strand provided for another contact element) in an unplanned fashion, which could in some circumstances cause a short-circuit.

The support ring 4 has the installation flange 23 which has at least approximately the same radial extent as the flange-like projection 10, which is why the installation flange 23 and the flange-like projection 10 come to lie at least approximately congruently on top of one another when the exemplary embodiment shown of the built-in plug connector 1 is assembled. The support ring 4 has in addition a cylindrical shell surface 24 extending axially in the direction of passage of the housing pot 3 through the support ring 4, wherein the internal diameter (or the radial extent/dimension) of the support ring shell 24 is adapted to the diameter (or the radial extent/dimension) of the cylindrical housing pot 3, in particular to the diameter (or the radial extent/dimension) of the cylindrical housing shell 9, in such a way that the housing pot 3 passed through the support ring 4 in the direction of passage bears against the inner side 27 of the support ring shell 24 with the outer side 26 of the housing shell 9, as a result of which the support ring 4 is supported on the housing pot 3.

In the exemplary embodiment shown of the built-in plug connector 1 according to the invention, the flange-like projection 10 of the housing pot 3 has the sealing lip 11 which runs around the flange-like projection 10, wherein the sealing lip 11 is pressed, when the plane surface 28 formed by the contact element carrier 7 and the housing pot 3 is applied against the rear side of the mounting plate, against the rear side of the mounting plate and thus seals the contact region between the flange-like projection 10 and the rear side of the mounting plate with respect to dust, water, humidity, and/or gases, in particular air.

In the embodiment shown, the support ring 4 has two blind bores 30 formed as a single piece and arranged diagonally opposite each other on the outer side 29 of the shell surface 24 of the support ring 4, wherein the blind bores 30 are designed at least predominantly as hollow cylinders open on one side, the shell surface of which (the (blind) bores do not, however, necessarily have to have a cylindrical or an at least approximately cylindrical shell surface) is formed at least partially by the shell surface 24 of the support ring 4. The blind bores 30 are arranged at two diagonally opposite corners 31 of the installation flange 23 and end, at that side 32 of the support ring 4 which is directed in the opposite direction to the direction of passage of the housing pot 3 through the support ring 4, flush with the installation flange 23, wherein the openings of the blind bores 30 extend within the diagonally opposite corners 31 of the installation flange 23, wherein the two openings of the blind bores 30 lie in the depression 19 of the installation flange 23, said depression extending as far as the two corresponding diagonally opposite corners 31 of the installation flange 23.

In each case a support structure 34, in particular with a triangular form, is arranged on that side 17 of the installation flange 23 which is directed in the direction of passage of the housing pot 3 through the support ring 4, at the two further diagonally opposite corners 33 of the installation flange 23 at which no blind bore 30 is arranged, wherein the respective support structure 34 extends as far as the shell surface 24 of the support ring 4 and is also arranged there. This embodiment has the advantage that the support ring 4, in particular the installation flange 23 of the support ring 4, is not distorted even when the fastening means are tightened firmly and the desired supporting effect is also ensured when the receptacle system 2 or built-in plug connector 1 according to the invention are in the state installed on the rear side of the mounting plate.

In the embodiment shown, the housing base 8 has three elements 35 which are each designed as a wall-like raised portion (rising into the internal space of the housing pot) running around one of the three openings 20 of the housing base 8. A corresponding mating element 36 of the contact element carrier 7, configured as a raised receptacle region designed to receive the contact element 21 on the contact element carrier 7, engages in each case in one of the cavities formed by the wall-like raised portions 35, wherein the respective wall-like raised portion 35 bears against the respective mating element 36 and the contact region formed as a result (in other words, also a press fit) fixes the contact element carrier 7 in the housing pot 3 and in addition is impermeable with respect to dust, water, humidity, and/or gases, in particular air.

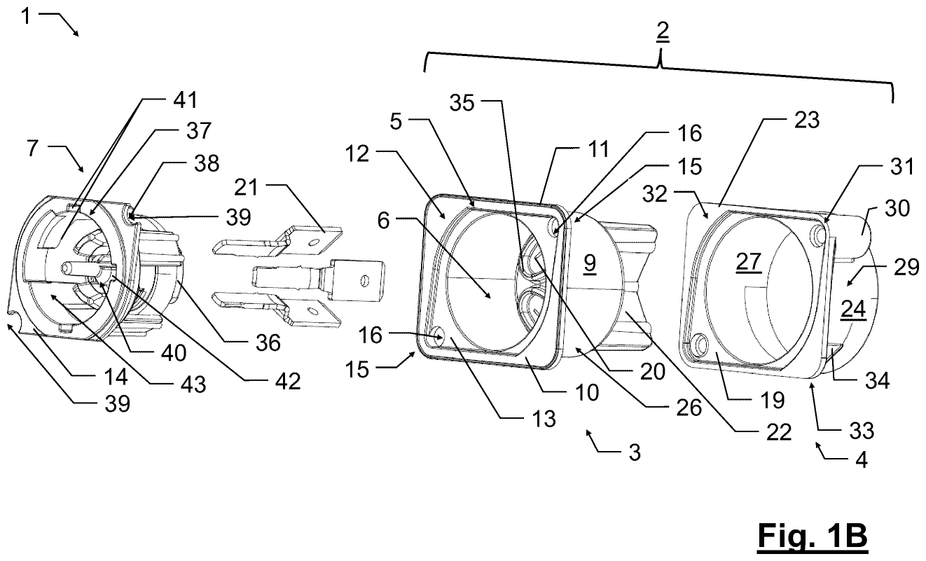

FIGS. 2A and 2B show perspective views of an exemplary embodiment of the built-in plug connector 1 according to the invention having an exemplary embodiment of the receptacle system 2 according to the invention in an assembled state. FIG. 2A shows the plug-in-side end 37 of the contact element carrier 7 and the plug-in-side end 5 of the housing pot 3, wherein the contact element carrier 7 is pushed so far into the housing pot 3 that the flange 14 of the contact element carrier 7 engages with an exact fit in the depression 13 arranged on that side 12 of the housing pot 3 which is directed in the opposite direction from the direction of insertion of the contact element carrier 7 into the insertion opening 6 of the housing pot 3 (or alternatively: on that side 12 of the housing pot 3 which is provided as the mounting-plate side for the installation of the receptacle system or the built-in plug connector on the mounting plate) and the plane surface 28 is formed there. This plane surface 28, which is formed on the side provided as the mounting-plate side of the built-in plug connector for the installation of the receptacle system or the built-in plug connector on the mounting plate, can then be applied to the rear side of the mounting plate, as a result of which the peripheral sealing lip 11 of the housing pot 3 bears against the rear side of the mounting plate. The housing pot 3 is additionally passed so far through the support ring 4 that the flange-like projection 10 of the housing pot 3 abuts the installation flange 23 of the support ring 4 and the raised portion 18 of the flange-like projection 10 engages with an exact fit in the depression 19 arranged on that side 32 of the support ring 4 which is directed in the opposite direction to the direction of passage of the housing pot 3 through the support ring 4. The flange-like projection 10 here comes to lie at least approximately congruently on the installation flange 23, and the contact element carrier 7, the housing pot 3, and the support ring 4 are arranged in such a way that the center axis of the contact element carrier 7, the center axis of the housing pot 3, and the center axis of the support ring 4 are coaxial.

In the case of the arrangement of the contact element carrier 7, the housing pot 3, and the support ring 4 as in the exemplary embodiment shown of the built-in plug connector 1 according to the invention, the two recesses 38 of the flange 14 of the contact element carrier 7, the two recesses 16 of the flange-like projection 10, and the two openings of the blind bores 30 of the support ring 4 are present in the diagonally opposite corners 15, 31, 39 of the respective component 3, 4, 7 in such a way that in each case one of the two recesses 38 of the flange 14 of the contact element carrier 7, one of the two recesses 16 of the flange-like projection 10, and one of the two openings of the blind bores 30 of the support ring 4 lie approximately congruently on top of one another, wherein the diameter of the recess 38 of the flange 14 of the contact element carrier 7, the diameter of the opening of the blind bore 30 of the support ring 4, and the diameter of the recess 16 of the flange-like projection 10 are at least approximately the same.

If the plane surface 28 is now applied, in particular with the circumferential sealing lip 11 of the housing pot 3, against the rear side of the mounting plate and a fastening means (for example, a screw) is passed through the mounting plate from the front side of the mounting plate until the fastening means engages in the blind bore 30, the fastening means is also automatically passed through the recess 38 of the flange 14 of the contact element carrier 7 and the recess 16 of the flange-like projection 10. If the fastening means is then tightened, the support ring 4 is drawn toward the rear side of the mounting plate, and the plane surface 28, in particular the sealing lip 11 of the housing pot 3, is pressed against the rear side of the mounting plate. Because the housing pot 3 is produced from the soft material, the flange-like projection 10 of the housing pot 3 is pressed against the rear side of the mounting plate by the contact pressure exerted by the fastening means, wherein slight compression of the flange-like projection 10 and the sealing lip 11 occurs, as a result of which the contact surface of the built-in plug connector 1 according to the invention with the rear side of the mounting plate is tight with respect to dust, water, humidity, and/or gases, in particular air, even without the use of further sealing means such as, for example, adhesives, sealing pastes, sealing rings (for example, O-rings), etc. Too great a deformation of the flange-like projection 10 of the housing pot 3, in particular around the recesses 16 of the flange-like projection 10, because the fastening means has been overtightened is, as described above, prevented by the stop formed by the hard contact element carrier 7.

In the exemplary embodiment shown in FIGS. 1A to 2B, the contact element carrier 7 is designed in such a way that the built-in plug connector 1 according to the invention is a male built-in plug connector (also referred to as a male appliance plug). For this purpose, the internal space 40, designed to receive the cable plug connector, of the contact element carrier 7 has the mechanical retaining elements 41 in the form of grooves and the mechanical closing element 42 provided for the catch of the catch slide on the cable plug connector. Before the built-in plug connector 1 according to the invention is fastened, the insertion opening 43 provided for the insertion of the cable plug connector into the built-in plug connector 1 is aligned with a corresponding mounting plate recess.

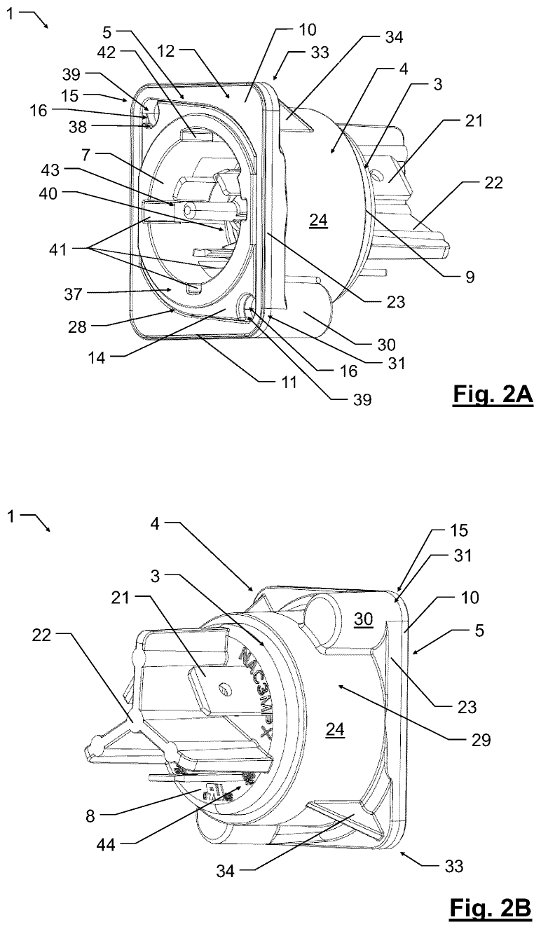

FIG. 3 shows a perspective view of an exemplary embodiment of the built-in plug connector 1 according to the invention having an exemplary embodiment of the receptacle system 2 according to the invention in the assembled state. In this exemplary embodiment, the contact element carrier 7 is designed in such a way that the built-in plug connector 1 according to the invention is a female built-in plug connector (also referred to as a female appliance plug). In the female built-in plug connector 1 shown, a support element 52 rising from the contact element carrier internal space 40 in the opposite direction to the direction 12 in which the cable plug connector is plugged into the contact element carrier 7 is arranged in the contact element carrier internal space 40, said support element having the mechanical retaining elements 41 in the form of tabs. Because, inter alia, the contact element carrier internal space 40 of the female built-in plug connector 1 has to receive or contain the support element 52 in addition to the cable plug connector, the contact element carrier 7 of the female built-in plug connector 1 according to the invention has a larger diameter (in other words: a greater radial extent/dimension) than the contact element carrier 7, shown in FIGS. 1A to 2B, of the male built-in plug connector 1 according to the invention. So that this enlarged contact element carrier 7 can be received by the receptacle system 2 according to the invention, the housing pot 3 and the support ring 4 in each case likewise have to be designed with an enlarged diameter or with an enlarged radial extent. However, because the built-in plug connector 1 according to the invention (with respect to the spatial extent, in particular also with respect to the radial extent) needs to have a specific standard dimension, for example the so-called D dimension, in the embodiment shown the shell of the outer surface of the contact element carrier 7, the shell of the housing pot 3, and the shell 24 of the support ring 4 are not configured with a cylindrical shape because otherwise the radial extent of the built-in plug connector 1 according to the invention would exceed the desired dimension. Instead, the shell surfaces of the respective components 3, 4, 7 are each flattened on at least one side, in particular on two diametrically opposite sides, in such a way that the radius is reduced on the plane surface 51 thus formed (for example, the radial extent of the support ring 4 ends flush with the radial extent of the flange-like projection 10 of the housing pot 3), as a result of which the radial extent of the built-in plug connector 1 according to the invention is limited and compliance with the desired standard dimension, in particular the D dimension, is thus ensured. In other words, the shell surfaces of the respective components 3, 4, 7 in each case run along a secant running through the respective shell surface such that a plane surface 51 is formed on this side.

It should generally be understood that the terms “cylinder” and “cylindrical” are not limited to circular cylinders and instead all types of cylinder are meant, in particular also elliptical cylinders or circular cylinders, in which at least one side is flattened or in which at least a subregion of the shell surface is designed with an enlarged or reduced radius. It should furthermore be understood that the support ring 4 does not necessarily have to have the shape of a circular ring. The term support ring is also understood to be an annular body in which, as shown for example in FIG. 3, at least a subregion of the circumference of a circular shape or a subregion of the shell surface deviate from a cylindrical shape. The support ring 4 can thus, for example, also have the shape of a hexagon nut or a hollow cuboid.

In the embodiment shown of the built-in plug connector 1 according to the invention, the internal space 40, designed to receive the cable plug connector, of the contact element carrier 7 does not have the mechanical closing element 42 provided for the catch of the catch slide on the cable plug connector. In the embodiment shown, the closing element 42 is provided to be arranged on a correspondingly configured second support ring 54.

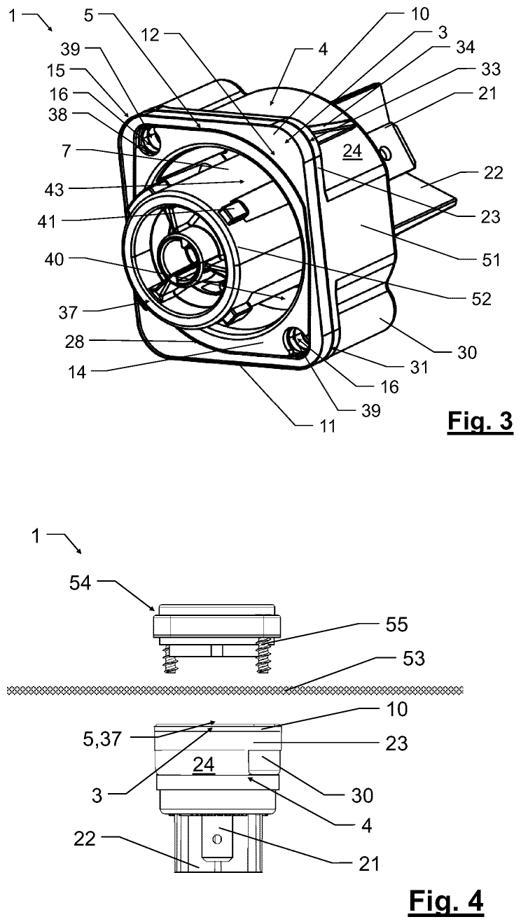

FIG. 4 shows a schematic illustration of the installation of an exemplary embodiment of the built-in plug connector 1 according to the invention on a mounting plate 53, wherein the receptacle system 2 and thus also the assembled built-in plug connector 1 has the second support ring 54 in the embodiment shown. The second support ring 54 is moved toward the mounting plate 53 from the front in such a way that the second support ring 54 surrounds with its opening the recess, provided for the passage of the cable plug connector, of the mounting plate 53. The second support ring 54 furthermore likewise has a support flange, wherein recesses provided for the passage of fastening means extend in two opposite corners of the support flange of the second support ring. When the embodiment shown of the built-in plug connector 1 according to the invention is properly installed, on the one hand, the center axis of the housing pot 3, the center axis of the support ring 4, and the center axis of the second support ring 4 are coaxial and, on the other hand, the recesses of the support flange of the second support ring 54, the recesses 38 of the flange 14 of the contact element carrier 7, the recesses 16 of the flange-like projection 10, and the openings of the blind bores 30 of the support ring 4 lie approximately congruently on top of one another, wherein the diameter of the recesses of the support flange of the second support ring 54, the diameter of the recesses 38 of the flange 14 of the contact element carrier 7, the diameter of the openings of the blind bore 30 of the support ring 4, and the diameter of the recesses 16 of the flange-like projection 10 are at least approximately the same. If a fastening means 55 (for example, a screw 55) is then passed through a recess of the support flange of the second support ring 54 from the front, the fastening means 55 is accordingly also passed through the recesses 38 of the flange 14 of the contact element carrier 7, the recesses 16 of the flange-like projection 10, and the openings of the blind bores 30 of the support ring 4 until the fastening means 55 then engages in the blind bore 30 and the components 3, 4, 7, 54 are thus drawn together and fastened. Because the embodiment shown of the built-in plug connector 1 according to the invention is supported on the mounting plate 53 both from the front and the rear and the fastening means 55 is passed through all the components 3, 4, 7, 54 from the front to the rear, the fastening of the built-in plug connector 1 on the mounting plate 53 is reinforced.

It should be understood that these illustrated figures schematically illustrate only possible exemplary embodiments. The different approaches can also be combined with one another and with methods of the prior art.

1. A receptacle system, configured to receive a contact element carrier and at least one contact element received in the contact element carrier in order to form part of a built-in plug connector, the receptacle system comprising:
a housing pot, configured such that the contact element carrier is insertable at least partially into the housing pot through an insertion opening at a plug-in-side end of the housing pot, wherein a flange-shaped projection is arranged at the insertion opening of the housing pot;
wherein the receptacle system is provided to be applied and fastened, with the flange-shaped projection of the housing pot, against a rear side of a mounting plate;
the housing pot is made from a material with a Shore A hardness in a range from 60 to 100 and the receptacle system;
a support ring made from a harder material than the housing pot;
wherein the housing pot is adapted to be passed through the support ring until the housing pot abuts the support ring with the flange-shaped projection such that, in a state mounted on the mounting plate, the flange-shaped projection is arranged between the mounting plate and the support ring; and
the support ring has a bore configured such that the support ring is fastened on the rear side of the mounting plate by a fastener passed through the mounting plate from a front side of the mounting plate and engaging in the bore.

2. The receptacle system (2) according to claim 1, wherein at least one of
a) the material of the support ring has a Shore D hardness in a range from 60 to 100, or
b) a material of the contact element carrier has a Shore D hardness in a range from 60 to 100.

3. The receptacle system according to claim 1, wherein at least one of the material of the housing pot, the material of the support ring, or the material of the contact element carrier is predominantly a thermoplastic, selected from the group consisting of at least one of the following thermoplastics:
polypropylene,
polyethylene,
polyurethane, or
polystyrene.

4. The receptacle system according to claim 1, wherein at least one of the housing pot, the support ring, or the contact element carrier is injection-molded, 3D printed, pressed, or vulcanized.

5. The receptacle system according to claim 1, wherein the housing pot further comprises:
a housing base at a rear-side end, situated opposite the plug-in-side end, of the housing pot, and
a housing shell extending from the insertion opening as far as the housing base,
wherein a radial extent of the support ring and a radial extent of the housing shell are matched to each other such that, when the housing pot is passed through the support ring, the housing shell bears against an inner side of the support ring and is supported thereby.

6. The receptacle system according to claim 5, wherein the housing base further comprises at least one of:
a) an opening provided such that, when the contact element carrier is inserted, together with the contact element, at least partially into the housing pot through the insertion opening in order to form part of the built-in plug connector, at least a part of the contact element is passed through the opening such that at least that part of the contact element which is passed through the opening of the housing base is present on an outer side of the housing base, or
b) an element, running around the opening of the housing base, which engages with a corresponding mating element of the contact element carrier, wherein the contact element carrier is fixable in the housing pot by the engagement of the element and the mating element,
wherein at least one of
a contact region formed between the contact element which is at least partially passed through and an inner side of the opening of the housing base, or a contact region formed between the element and the mating element,
is impermeable with respect to dust, water, humidity, and/or gases, in particular air.

7. The receptacle system according to claim 1, wherein the flange-shaped projection has a sealing lip extending around the flange-shaped projection, wherein the sealing lip is arranged on a side of the flange-shaped projection which is directed in an opposite direction to a direction of insertion of the contact element carrier into the insertion opening of the housing pot, and is designed to be pressed against the rear side of the mounting plate when the support ring is fastened to the rear side of the mounting plate by the fastener in order to supply a contact region, between the flange-shaped projection and the rear side of the mounting plate, which is impermeable with respect to at least one of dust, water, humidity, or gases.

8. The receptacle system according to claim 1, wherein the flange-shaped projection has a recess, matched to the bore of the support ring, for the passage of the fastener, and a diameter of the recess corresponds at least approximately to a diameter of the bore.

9. The receptacle system according to claim 1, wherein at least one of
a) the support ring a radially outwardly extending installation flange,
b) the installation flange of the support ring has the bore,
c) the housing pot is adapted to be passed through the support ring so far that the housing pot abuts the installation flange of the support ring with the flange-shaped projection (10), or
d) a radial extent of the flange-shaped projection and a radial extent of the installation flange are at least approximately the same.

10. The receptacle system according to claim 1, wherein the support ring has, on a side of the support ring which is directed in an opposite direction to the direction of passage of the housing pot through the support ring, a depression into which a raised portion, designed correspondingly as a mating piece and arranged on a side of the flange-shaped projection which is directed in the direction of passage of the housing pot through the support ring, is adapted to be pushed with an exact fit such that at least one of a) a center axis of the housing pot and a center axis of the support ring are coaxial, or b) the housing pot is adapted to be fixed on the support ring by a press fit which is formable between the raised portion of the flange-shaped projection and the depression of the support ring.

11. The receptacle system according to claim 1, wherein the housing pot has, on a side of the housing pot which is directed in an opposite direction to the direction of insertion of the contact element carrier into the insertion opening of the housing pot, a depression into which a flange, formed correspondingly as a mating piece, of the contact element carrier is adapted to be pushed with an exact fit such that at least one of a) the center axis of the housing pot and a center axis of the contact element carrier are coaxial, b) the contact element carrier is adapted to be fixed on the housing pot by a press fit which can be formed between the flange of the contact element carrier and the depression of the housing pot, or c) a plug-in-side end of the contact element carrier and the plug-in-side end of the housing pot form a plane surface, wherein the plane surface is designed to be applied against the rear side of the mounting plate.

12. The receptacle system according to claim 1, further comprising
a second support ring, wherein the second support ring is provided to be fastened to the front side of the mounting plate by the fastener, the front side of the mounting plate is directed toward the side from which the cable plug connector is moveable toward the built-in plug connector situated in a state installed on the mounting plate,
the second support ring at least one of a) has a radially outwardly extending support flange, or b) has at least one recess extending in a corner of the support flange of the second support ring, and
wherein the second support ring, the housing pot, and the support ring are adapted to be arranged on the mounting plate in such a way that at least one of a) a center axis of the second support ring, a center axis of the housing pot, and a center axis of the support ring are coaxial, b) the recess of the support flange of the second support ring, the recess of the flange-shaped projection of the housing pot, and the bore of the support ring lie on top of one another approximately congruently, or c) the fastener provided for fastening the receptacle system to the mounting plate and moved toward the front side of the mounting plate for this purpose is adapted to be passed through the recess of the support flange of the second support ring, through the recess of the flange-shaped projection of the housing pot, and through the bore of the support ring, and the fastener exerts a respective force on said components of the receptacle system, as a result of which the second support ring is pressed against the front side of the mounting plate, and the flange-shaped projection of the housing pot and the support ring are pressed against the rear side of the mounting plate and the fastening of the receptacle system to the mounting plate is thus reinforced.

13. A built-in plug connector for making a lockable plug connection to a cable plug connector matched to the built-in plug connector as a mating piece and which is adapted to be plugged into an opening of the built-in plug connector, wherein transmission of a signal is enabled by making the plug connection between the built-in plug connector and the cable plug connector, wherein the built-in plug connector comprises:
at least one contact element adapted to come into contact by making the plug connection with a contact element mating piece on the cable plug connector and consequently to supply the transmission of a signal via the plug connection, and
a contact element carrier, wherein the at least one contact element is received by the contact element carrier,
the built-in plug connector further includes the receptacle system according to claim 1, wherein the housing pot is passed through the support ring until it abuts the flange-shaped projection, and the contact element carrier is inserted, together with the at least one contact element, through the insertion opening at least partially into the housing pot of the receptacle system.

14. The built-in plug connector according to claim 13, wherein the contact element carrier has a locking mechanism for the cable plug connector for supplying a mechanically lockable plug connection, and an internal space, formed for receiving the cable plug connector, of the contact element carrier at least one of
a) has a mechanical retaining element which is provided in order to block a retaining element mating piece on the cable plug connector in terms of an axial movement in a direction in which the cable plug connector is pulled out, formed of a first part of a locking mechanism which is adapted to be actuated by rotation, in a screw-in direction, of the cable plug connector in a state in which the cable plug connector is pushed at least partially into the internal space, or
B) has a mechanical closing element which is provided in order to effect engagement of a catch, connected to the catch slide, of the cable plug connector into the closing element, in the form of a second part of the locking mechanism which is adapted to be actuated by displacement of a catch slide on the cable plug connector, and thus to block the cable plug connector in terms of rotation in an unscrewing direction which is directed counter to the screw-in direction.

15. The built-in plug connector according to claim 13, wherein the flange of the contact element carrier has recesses for the respective passage of the fastener, and the recesses of the flange of the contact element carrier extend within diagonally opposite corners of the flange of the contact element carrier.
